(19) United States
(12) Patent Application Publication
(10) Pub. No.: US 2024/0016683 A1
(43) Pub. Date: Jan. 18, 2024

(54) transferring the patient from bed to bed without injuring or shaking the patient with the rail movement mechanism

(71) Applicants: Hamid Akhavein Ansari, I, Tehran (IR); Majedeh HOSSEINNEZHAD DARYAKENARI, Tehran (IR)

(72) Inventors: Hamid Akhavein Ansari, I, Tehran (IR); Majedeh HOSSEINNEZHAD DARYAKENARI, Tehran (IR)

(73) Assignees: Hamid Akhavein Ansair, I, Tehran (IR); Majedeh HOSSEINNEZHAD DARYAKENARI, II, Tehran (IR)

(21) Appl. No.: 18/031,631

(22) PCT Filed: Feb. 28, 2021
(86) PCT No.: PCT/IB2021/051668

§ 371 Date: Apr. 13, 2023

(30) Foreign Application Priority Data
Oct. 13, 2020 (IR) 13995014000300637

(51) Int. Cl. A61G 7/10

(52) U.S. Cl. CPC A61G 7/1034; A61G 7/1026; A61G 7/103

(57) ABSTRACT

A bed with four moving wheels, the bed has ability to transfer the patient to the lateral bed along with the sheet, comprises two lifting jacks for raising or lowering the frame with sheets, two high power motors for moving the bed in the lateral direction by rack and pinion gears and four low power motors that rotate simultaneously and in opposite directions for locking the sheet at the four corners by rotation of motors and the whole system is powered by a battery and the motors and jacks are controlled by a control panel.

### CROSS-REFERENCE TO RELATED APPLICATION

This application claims the benefit of priority from Iranian Patent Application Ser. No. 139950140003006376, filed in Oct. 13, 2020, which is incorporated herein by reference in its entirety.

### TECHNICAL FIELD

This disclosure relates to medical devices and more specifically relates to a bed for patients.

### BACKGROUND

Hospitals, as the center of healthcare transfer, are among the factors that control the success of the healthcare network and the fair expansion of health care in all levels of the network. Under the current circumstances, hospitals within the health care network are often isolated and concentrated outside the referral network in the country for an important reason in terms of health care and steam treatment.

Most types of hospital beds are needed due to their age, safety facilities and equipment, which if this causes you to need physical and mental, will not be provided during the painting period. In case of using non-standard and old beds, due to the low safety of these beds and also the difficulty in moving, many problems are created for the patient and the treatment staff. The design and production of a hospital bed should be such that if the patient's comfort and safety standards are met, you will be satisfied and the staff will be treated. The current technical problem with a hospital bed is the lack of access to transfer the patient from the floor to the bed or from bed to bed. A bed may already be made for any hospital activity, which is for medical hospitals. For the convenience of the patient when changing sheets, it has now become a serious problem for the patient and nurses when moving the patient.

The purpose of this plan is to facilitate nursing operations in transferring and transferring and serving the patient, also reducing the patient's pain and injury in transporting him to another hospital or other beds, reducing hospital adjustment, increasing the use of hospital beds, etc. [symbol] Problems such as difficult transportation of the patient from bed to bed to help your hand, changing sheets with difficulty and continuing to move and special actions such as turning the patient right or left sideways or injured and injured that if put pressure and air pressure to all parts of the body, especially in anesthetized information, move and move if the bed sore is likely to increase for a long time, and there is unconscious and incurable monitoring that hospitalization is necessary.

Hospital Bed Device; U.S. Pat. No. 5,054,140

A hospital bed device is provided that includes hydraulic cylinders for lifting the rollers that are located along each side of the bed. The rollers are driven by fractional horsepower electric motors and a belt is attached to the rollers so that the patient can lift and move the belt while sleeping. This device provides a safe and convenient way to rotate hospitalized patients who may otherwise develop bed sores, pneumonia or other subsequent illnesses.

The above invention is a hospital bed that is placed on both sides of the bed using hydraulic cylinders, while the invention of the bed servant is to transfer the patient from bed to bed using a sheet under the patient that one can place Laminate bed sheets. This part is locked and in proportion to the patient's weight, the higher the patient's weight, the more this part is locked so that the patient can be transferred to another bed.

Medical Mobility System, U.S. Pat. No. 5,038,424

The system for transporting the patient in a medical center from one level to another consists of a flexible network with the opposite end wrapped around a pair of cylindrical rollers. The cylindrical rollers engage rotationally between a drive motor and a stationary bearing located at each longitudinal edge of a support to extend the flexible grid over its entire surface. A maneuverable table is similarly equipped with a drive motor and bearings at each longitudinal edge. The table is placed next to one edge of a support and a cylindrical roller is removed between the drive motor and the bearing stationary at that edge of a support and placed between the drive motor and the other bearing at the edge around the table. As the actuator motor is activated at the edge around the table, the cylindrical roller is rotated, thus screwing the web onto it and simultaneously transporting the patient from a stand to the table. A cylindrical roller on the remote edge of a bed can be detached from it and placed between the drive motor and the idle bearing at the edge near the table. The table can then be maneuvered at any location in the medical center. Preferably, the drive motors are all hydraulic, allowing the system to operate safely in areas of the medical center where oxygen is used.

The invention of a super system for patient transport with the opposite end wrapped around a pair of cylindrical rollers. Cylindrical rollers engage in rotation between a drive motor and a stationary bearing located on each longitudinal edge of a support, but the invention of the servant is a bed in which the patient himself does not need to rotate in different directions alone because some patients secrete. They cause the device to get dirty, but in this method, due to patient transfer, the device stays clean and does not need to be cleaned.

Gurney, U.S. Pat. No. 5,022,810

A transfer device is provided to move the patient from the first place to the second place, especially the canopy for transferring the patient. The device includes a bed mechanism for carrying the body to be transferred and a support structure to support the patient mechanism and to transfer the patient mechanism between the first and second place. In one step, the bed mechanism can be rotated according to the support structure to help transfer the patient. In the second stage, the bed mechanism can also be moved laterally and transversely according to the support structure. Below the support structure, there are excavators that can be extended out of the device to stabilize the device and prevent it from cracking, as the bed mechanism expands transversely according to the support structure.

The above invention is a device such as a canopy to transport the patient, while in the invention of the servant, the patient is transported using sheets so that a person can collect the sheets by placing them in the sheets and locking the sheets in that part. Transfer the patient's power to a side bed. It is also easy to transfer patients who have a bed sore or a problem in their spine.

Patient Mover; U.S. Pat. No. 4,747,170

The patient is transferred laterally from the first surface, such as a bed, to the second surface, such as glass, by the patient stimulating the invention. The patient is a distant movement. This works by opening a wire from a roller that rotates on a standing frame mounted on a wheeled stand, until the mattress web covers the board and is adjacent to the edge of the bed. The edge of the sheet adjacent to the web is removed from under the mattress and inserted into the hole of the pipe through the slit of the pipe connected to the web. The sheet is locked by inserting a rod into the hole in the pipe. The wire is wrapped around the roller and gently pulls the patient carrier plate into the duct. The edge of the sheet is then released by removing the rod from the hole.

The super-patient invention is transferred laterally from the first level, like a bed, to the second level by the patient who stimulates the invention, while in the patient's servant's invention, there is no need for many people and only one person is present by placing the sheet inside the sheet. The collector is locked and the patient can be transferred to another bed by lifting the patient with the relevant part.

Separator Assembly for Transfer Mechanisms U.S. Pat. No. 4,077,073

A detachable set for transport mechanisms, especially those used to transport and transport non-outpatients in the hospital, and includes a belt mounted on a thin, flexible separating plate, a retaining bar that can be adjusted along the rear edge. The separator plate is located and an actuator roller is held by the rod The grater is supported on the edge in front of the separator plate. An organization of camshafts extends between the retaining rod and the rear edge of the separating plate to adjust the distance between the retaining rod and the separating plate so that the belt tension trained on the drive roller, retaining rod and separating plate is adjusted. Cumming rods work either to adjust the distance between the actuator roller and the front edge separator plate in a parallel relationship or in a condensed relationship for belt tracking purposes.

The above invention is a system for transporting the patient using the actuator roller and the separating plate, but the invention of the patient's servant is locked without the need for many people and only in the presence of one person by placing the sheets inside the collector and lifting the patient can be transferred to another bed with the relevant part.

Hospital Trolleys, U.S. Pat. No. 4,011,609

The present invention relates to a hospital trolley that has a support member and a framework with a collaboration guide to enable the patient to be transferred from one trolley to another. It also provides a means of securing two trolley frames with interconnected plates.

The above invention is an electric wagon for transporting patients, but my invention is a device for transporting patients only in the presence of a person who puts the sheet under the patient in the sheet and collect the patient from bed to bed by locking the bed. Transferred.

Mechanical Gurney, U.S. Pat. No. 5,163,189

A movable, automatic and powerful steering wheel is provided which includes a flexible and flexible support structure from which the patient support structure is adjusted for lateral displacement of the groove between the first position on the support structure and the wide position. Externally appearing is supported. Side margin of the support structure. The patient support structure consists of a conveyor structure that responds to the lateral transfer of the patient from the support structure to the change of patient support structure. It is more operational to transfer the patient laterally from the patient support structure than in the opposite direction. The patient changes with respect to the support structure and is at exactly the same rate as the patient's support structure with respect to the support structure.

The above invention is a movable, automatic and powerful steering wheel set for lateral movement, while the invention transports the patient servant to another bed using the sheet under the patient.

Cargo, Hospital and Surgical Stretcher Registration Number in Iran: 80328

This device can transport patients with different types of hospital beds and stretchers (between hospital wards) and transfer surgical beds, necessities of hospital wards and operating rooms, surgical fluids such as urology, surgical sets and equipment, documents, laboratory and surgical samples, closed Patient's medical devices and . . . are provided without pressure and force and in a completely safe, efficient and without burnout. Summary Function Description: The present invention is an electric cargo handler, hospital beds (stretchers) and surgery. The user connects a bed or a stretcher to the device and immediately after entering the information (via the disconnection and connection keys installed in the control panel) issues the command to move the device. For complete control of the movement and rotation of the hospital bed and surgery and separate transfer of each by the device, the end of the hospital bed is separated from the ground by a stud box connected to the electric lift to the appropriate height (surgical bed is fixed only by two horns on either side of the stud box) it is possible). Hospital and operating room supplies, urological surgery fluids, surgical sets and equipment, documents, laboratory and surgical specimens, patient packages and medical equipment, etc. are placed in the compartment behind the power jack. To be. The force required to move is generated by the DC gearbox motor and transmitted through the chains to the shaft and finally to the wheels, causing it to move at the desired speed. The direction of movement is controlled by a mechanical parallel power steering. By rotating the steering wheel, the user takes the movement path out of direct mode and determines the direction of movement.

The above invention is an electric carrier for hospital and surgical beds. The user connects a bed or a stretcher to the device and immediately after entering the information (through the disconnection and connection keys installed in the control panel) issues the command to move the device, while my invention is a type of hospital bed that is for transfer. The patient can be lifted up and transferred to the side bed without the need for more people and only by placing the sheets side by side and locking the patient.

Two-Piece Wheeled Plate Transporting the Patient from the Hospital Beds, Registration Number in Iran: 97202

In the proposed design, two metal rails that are installed on the moving bed and also a two-piece stretcher with 6 wheels in each piece are used to move the patient from the fixed bed to the moving bed. The method is that first we place the wheeled bed on which we have installed the rails next to the fixed bed, then we increase the height of the wheeled bed more than the fixed bed so that the rails open easily on the fixed bed, when this happens, we reduce the height so that the wheeled bed and the fixed bed are level, in which case the opened rails will not bear weight and the weight falls on the fixed bed, then we open two pieces of the designed wheeled stretcher and one piece. We turn the patient to the side by turning the patient sideways, then we turn the patient to the other side and place the other piece under the patient, then we easily connect the stretcher pieces and now with the smallest force, the stretcher is fixed from the bed to. It is transferred on a wheelchair, we also do the same to transfer the patient from a wheelchair to a fixed bed.

The above design is actually two moving metal rails that are installed on the bed and also a two-piece stretcher formed to move the patient from a fixed bed to a moving bed is used. In this design, the patient is rotated several times in different directions. But in my invention, a device has been designed that can transfer the patient from one bed to another without the need for other people and only with the presence of the nurse, and the nurse can collect the sheets by placing the sheets and rotating the sheets and locks. Fold the sheets between these two sheets and then the patient is transferred to the side bed.

Portable Chairs that can be Turned into Hospital Beds Registration Number in Iran: 75926

The design is portable and can be turned into a chair and can be used in hospitals or military organs, etc. Its purpose is to save money and provide comfort for patients and even their companions so that they do not occupy this space. The design is made of aluminum alloy and the weight considered for it is 10 kg. The advantage of this design compared to other designs is: portability, lightness, low cost of consumption and its dual use.

The above design is in fact a portable chair and can also be converted into hospital beds, in which case it is possible to avoid taking up more space, but my invention is a device for easier transfer of the patient to other beds so that only in the presence of the nurse can the patient be lifted by placing the sheets side by side and locking this part and then transferred to the side bed.

Multifunctional Hospital Beds Registration Number in Iran: 68467

Imagine a situation where a casualty or an unconscious patient who is also overweight has to change sheets, move from one hospital to another, or move from bed to bed, or has a broken limb or possible spinal cord injury. What can be expected from the weak and weak nurses or the disabled companion of the patient who can not help the nurses or is late and the hospital is deserted? This is where the flat bed machine makes things easier for the patient or the nurse and the doctor.

The above invention is a kind of flatbed machine. It is not for transferring the patient, while the servant's invention is a means of transferring the patient from bed to bed only with the presence of a nurse, so that.

only by placing the patient's sheets in the sheets, the sheets can be folded and locked. He moved to the next bed.

### SUMMARY

A hospital bed is a bed that is designed and made for the well-being of patients. Although it is called a hospital, today many people use it for the use of patients and their loved ones at home, and also the transfer of patients in hospital beds is a very important issue that does not require the presence of many people during the transfer and the nurse can take the patient in. To solve this problem, we have designed a bed that has the ability to move the patient from bed to bed without the need for a special person. The upper part of the bed has four motors that are locked when the power does not reach them, which is connected to two sheets that collect when the nurse puts the sheets next to the sheets by hand, and these motors, contrary to twist in the same direction and the sheets are locked and adjusted to the patient's weight, and the heavier the patient is, the more the sheets are locked, so the patient can be transferred from bed to bed without the need for other people.

### BRIEF DESCRIPTION OF THE DRAWINGS

FIG. 1—General view of the bed with description number

FIG. 2—Open view of the bed with description number

FIG. 3—Bottom view of the bed with description number

FIG. 4—Flat overview

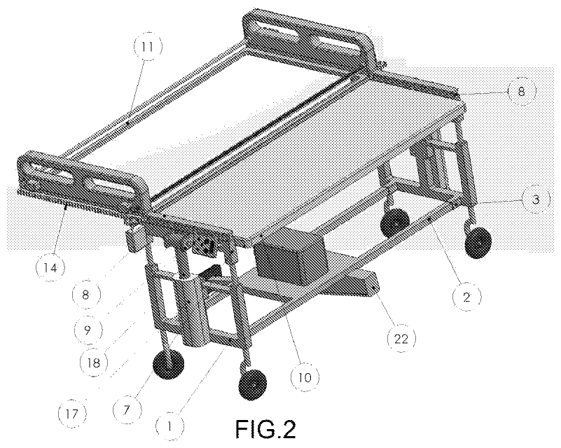

FIG. 2—One view of the bed

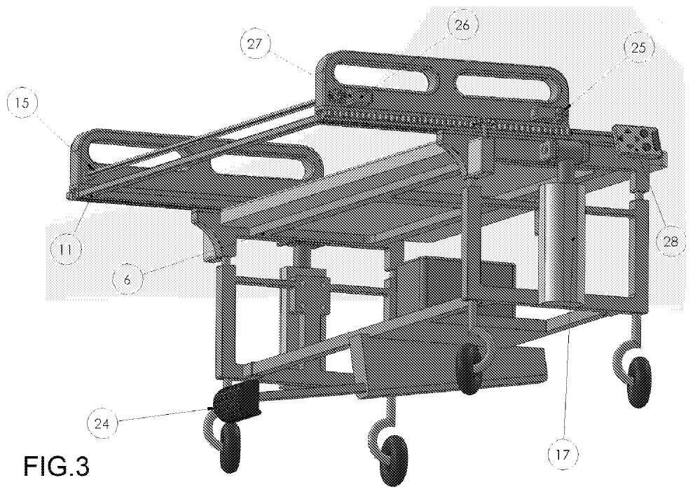

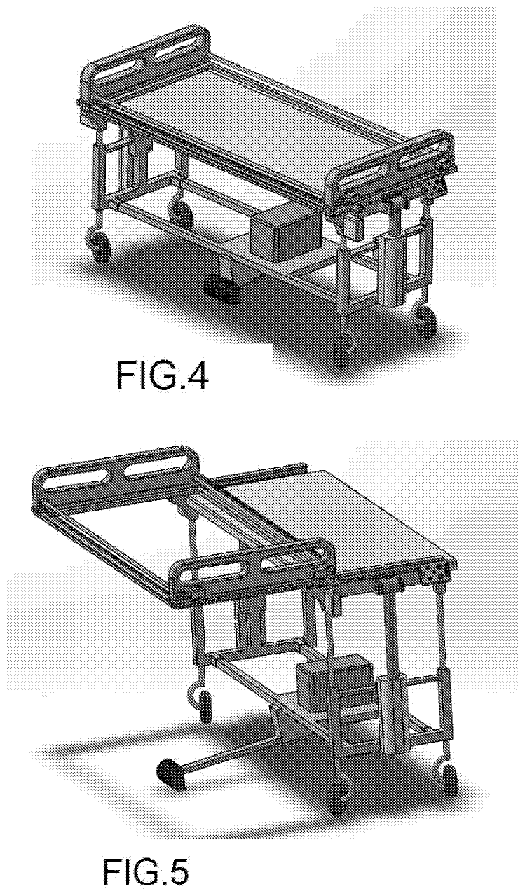

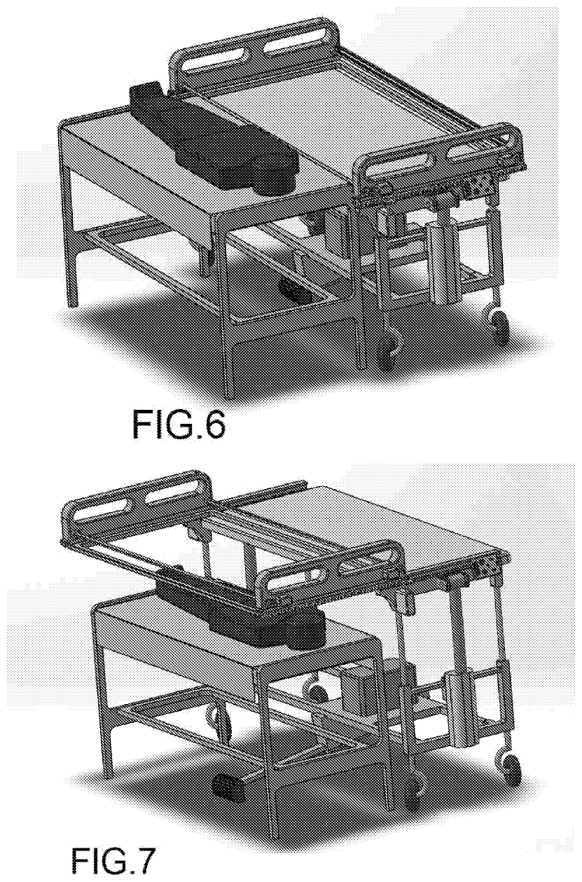

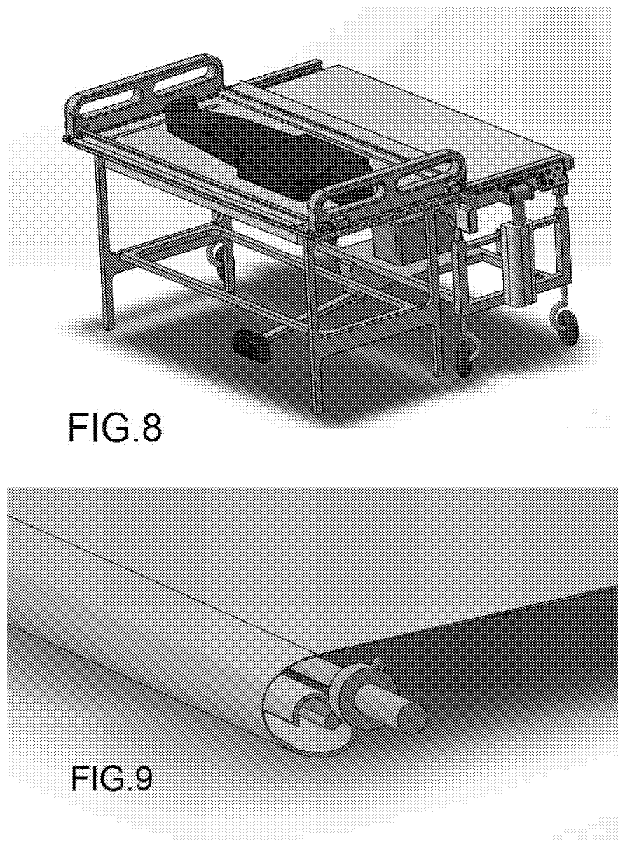

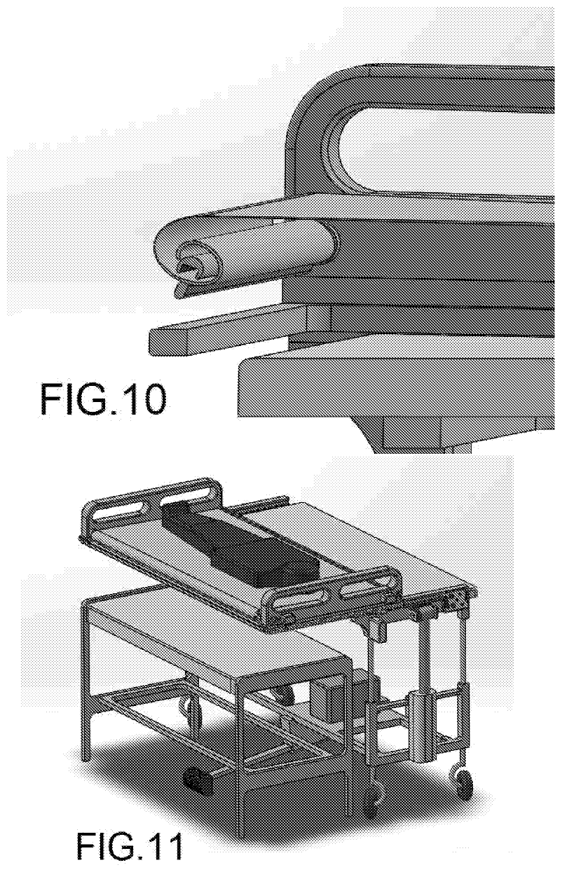

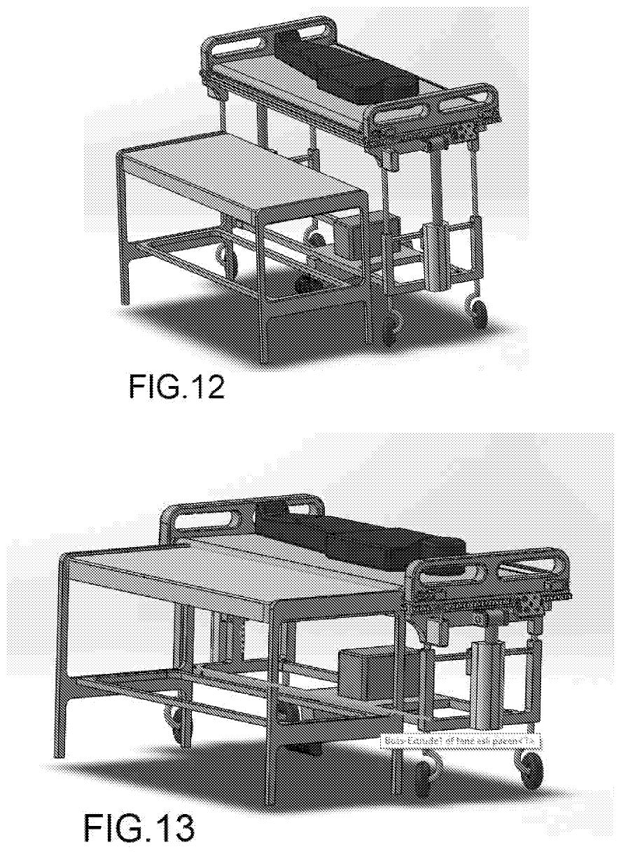

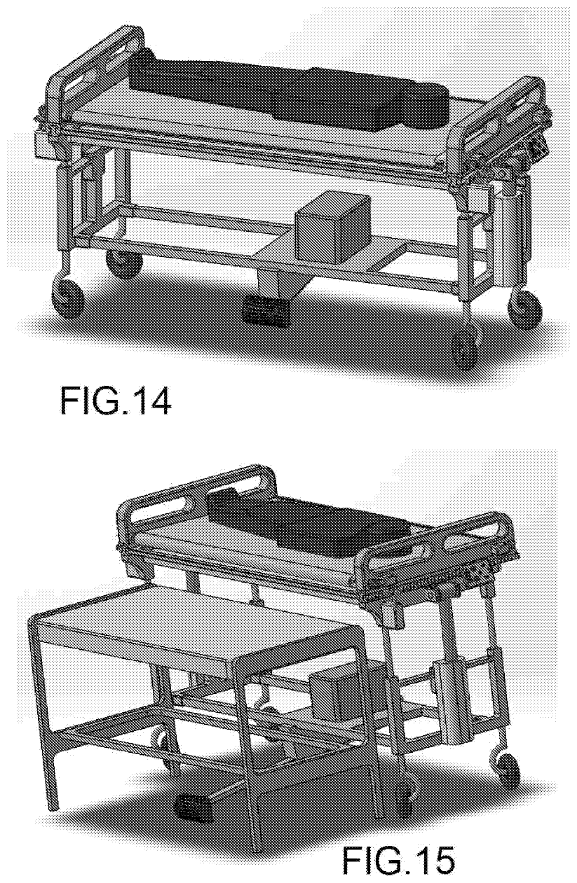

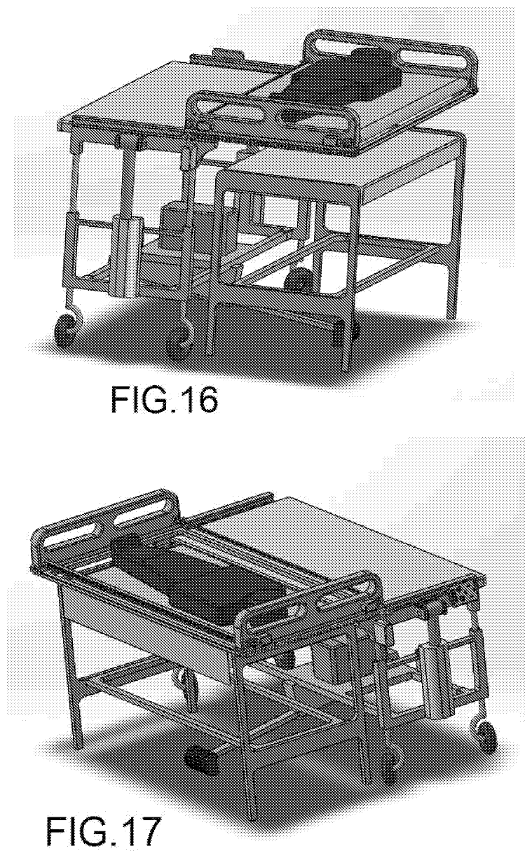

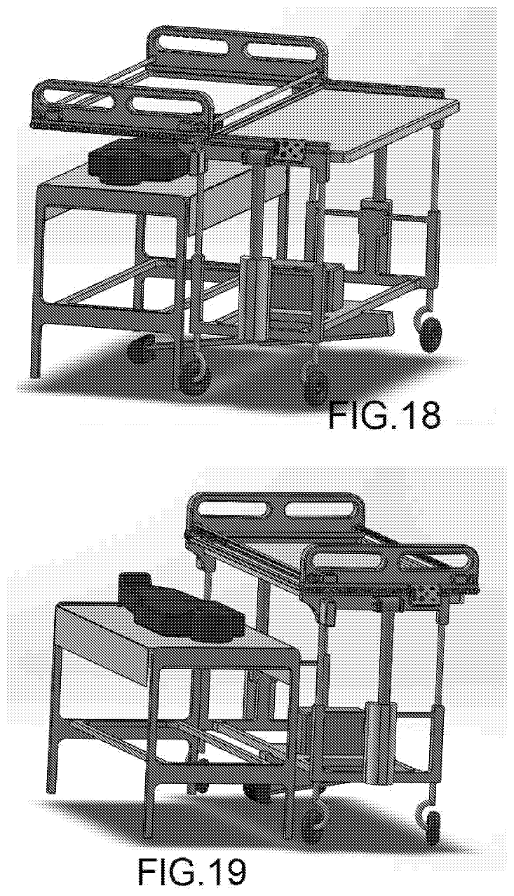

FIG. 3—One view of the bed

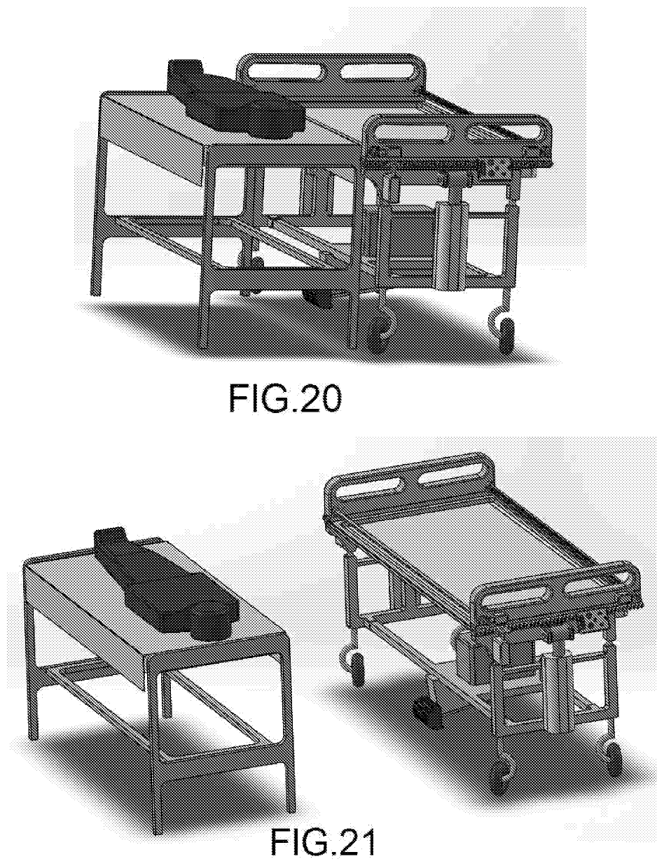

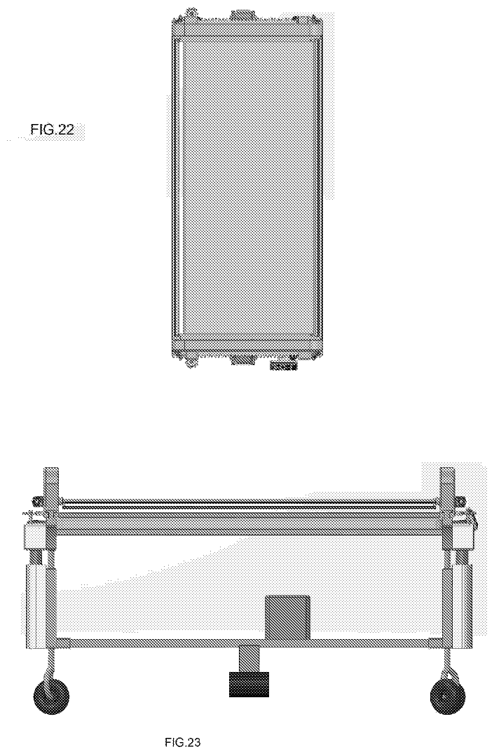

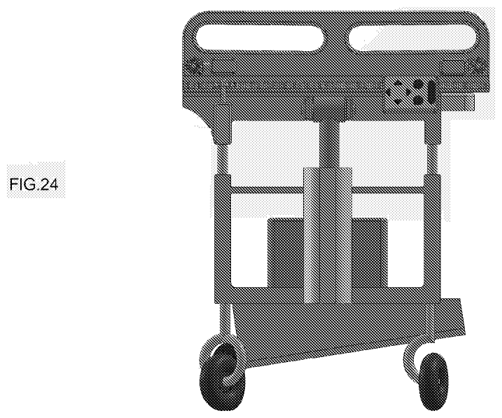

FIG. 4—One view of the bed

FIG. 5—Open view of the bed

FIG. 6—View of the bed next to the patient's bed to be transferred to another bed

FIG. 7—Open view of the bed for patient transfer

FIG. 8—Collect the sheets in the sheets

FIG. 9—How to place the sheets in the sheets

FIG. 10—How to place the sheets in the sheets, collect from another view

FIG. 11—Transferring the patient from the side bed on the device itself

FIG. 12—Transferring the patient from the side bed on the device itself

FIG. 13—Placing the patient on the mattress of the device

FIG. 14—Patient transfer by this invention

FIG. 15—Placing this device next to the bed on which the patient should be placed

FIG. 16—Lifting the patient and transferring him to the side bed

FIG. 17—Putting the patient on the bed

FIG. 18—Raising the upper part of the bed to move the bed to the desired location

FIG. 19—The bed is in a normal position

FIG. 20—Bed in normal condition

FIG. 21—Transferring the bed to another place

FIG. 22—Flat top view

FIG. 23—Flat side view

### DETAILED DESCRIPTION

A hospital bed is a bed that is designed and made for the well-being of patients. Although it is called a hospital, today many people use it for the use of patients and their loved ones at home, and also the transfer of patients in hospital beds is a very important issue. The important point during the transfer is that there is no need for many people and the nurse.

To be able to move the patient if needed. To solve this problem, we have designed a bed that has the ability to move the patient from one bed to another by only one person without the need for many people. In this device, due to the transfer of the patient with the sheet under the patient, the patient's body does not come into direct contact with the device, in case of some discharge, the device does not even get dirty and does not need constant cleaning It is lower and also this device is suitable for transporting patients who have bed sores or problems in their spine and does not cause harm to patients.

The components of the bed are as follows: The main body of the bed is made of aluminum with the aim of being lighter, 4 moving wheels with 360 degree rotation, there are six stepper motors in the moving upper part of the bed, two of which have higher power than the other four.

These two stepper motors are located on both sides of the bed, each of which is applied by a gear to the long shoulder gears (which are responsible for moving the upper part of the bed to the left or right). In the upper part of the bed, there are two collecting sheets (left and right), each of which is controlled by two stepper motors (four in total), which always rotate simultaneously and in opposite directions, and their material can be made of steel or aluminum alloys in which both sides of the sheet are locked. The collector sheet consists of a long bar and a grooved cylinder of equal length (on the left and right of the upper part of the bed), the diameter of the groove inside the cylinder is a few millimeters larger than the diameter of the bar.

There are two pins at the top of the bar and a grooved cylinder that connects the two (according to the plan) and limits the internal distance between the bar and the bottom of the cylindrical groove (between which the sheet is placed) (between 0 and about 50 Mm). When the nurse places the sheets next to the sheets collector by hand, by turning the sheets collectors (controlled by the nurse through the panel) which are in opposite directions, the sheets are placed between the rod and the cylinder groove and locked.

The sheet collectors rotate around themselves and in opposite directions until the sheets are completely stretched. The heavier the patient's weight, the heavier the sheets and cylindrical sheets are according to the sheet collector mechanism.

More pressure is applied to the sheets and the sheets are completely in the sheets are locked. To place the patient on the other bed, the retractors move against the locking rotation until the force is removed from the retractor and the rod is detached from the grooved cylinder (limited to 50 mm performed by the intermediate). And the sheets are released from them, so that the patient can be transferred from bed to bed without the need for other people.

A white mattress plate on which the patient is placed when transferring the patient (from one room to another). There are two lifting jacks on both sides of the bed (top and bottom) that are responsible for adjusting the height of the upper part of the bed, lifting and placing the patient. At the bottom of the bed is an opening jack to maintain balance during lifting and transfer (patient to the side bed), battery (power supply), a green panel at the top to control motors and bed jacks.

The design of this bed is done in such a way that there are four wheels at the base of the bed, which is to move the bed, and the large lever at the bottom is for situations when we want to lift the patient, in fact, when the lever is opened, it does not allow the patient's bed to be left, and in the upper part, there is a red box, which is actually a battery or the same power supply, which can be recharged when the city electricity is finished. Which moves left and right on two rails (top and bottom of the upper part) that can withstand high weight. Six upper part motors (two more power + four less power), stepper motors have gearboxes and up to when commanded, they lock in place and do not move.

Explanation of Shapes, Maps and Diagrams

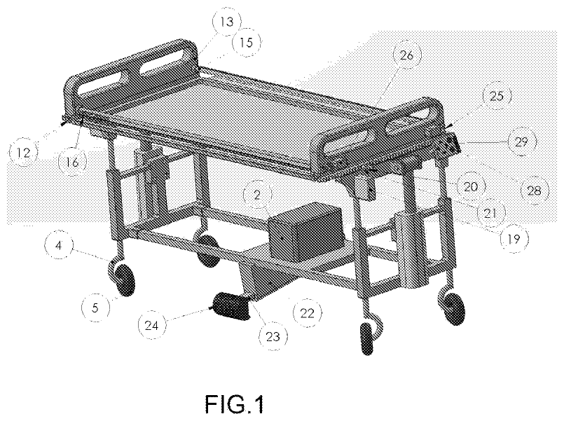

Description of Components(FIG. 1, FIG. 2, FIG. 3)

1—The lower body of the bed

2—Flat chassis

3—Chassis connection and body under the bed

4—Wheel base

5—Wheels

6—Chassis of the upper part of the bed

7—The body of the upper part of the bed

8—Rails connected to the upper body of the bed

9—Holding arm of the moving part of the flat lifting jack

10—The soft plate on which the patient rests

11—Chassis holding the moving upper part of the bed

12—Rails connected to the moving upper part of the bed

13—The forehead of the moving upper part of the bed

14—Comb gear

15—Gather the grooved cylinder of sheets

16—Collect the sheets

17—Fixed body of lifting jack

18—Movable body of lifting jack

19—Stepper motor of flat gear movement left and right

20—Stepper motor shaft moving the flat left and right

21—Gear to transfer power from the engine to the shoulder gear to move the flat left and right

22—Fixed body of the opening jack (to prevent the bed from overturning)

23—Movable body of the opening jack (to prevent the bed from overturning)

24—Rubber base of removable body of removable jack

25—Collect the gear to transfer power from the stepper motor to the sheets

26—Collect the bed stepper motor

27—Assemble the stepper motor shaft

28—Flat control panel

Clear and Precise Statement of the Advantages of the Claimed Invention Over Previous Inventions

In this plan, the patient can be easily transferred from bed to bed without the need for other people and only in the presence of one person or only the presence of a nurse.

There is a large lever in the lower part of the bed that does not allow the patient's bed to overturn.

This bed has a number of middle chassis. Two steel jacks are connected to the head and bottom with large arms, which are used to transport the patient upwards.

Rails can bear the weight of the patient, even in patients with heavy weight.

5—When the nurse puts the sheets next to the sheets collector by hand and these motors twist in the opposite direction and the sheets next to the sheets collector is locked.

In this method, because the patient is transferred using sheets, as a result, if there is some discharge from the patient's body, the device does not get dirty and does not need constant cleaning.

Using this device for patients who have bed sores or problems in their spine does not cause harm to the patient.

At least one practical method for applying the invention.

This plan can be used in hospitals to take the patient from bed to bed, in which case the patient can be transferred to another bed without the need for other people by placing the patient on a sheet and locking the sheets inside the sheets.

[symbol]

Explicit Mention of the Industrial Application of the Invention

This plan can be used in hospitals, laboratories of veterans and the disabled, nursing ordinary and incurable patients in homes that need a nurse.

1. What is claimed is a bed to transport the patient, which has the ability to move the patient to the side bed by placing a sheet in the bedding compartment by its components, which includes: 4 moving wheels with 360 degree rotation, six motors A step at the top, two more power + four less power (stepper motor), two sheets (left and right), a plate on which the mattress is located, two lifting jacks on both sides of the bed, a jack Droppable, battery (power supply), panel formed.

2. According to claim 1, there are two stepper motors on either side of the bed, each of which is applied by a gear to the long shoulder gears (which are responsible for moving the upper part of the bed to the left or right). Step motors have gearboxes and lock in place and do not move until they are commanded.

3. According to claim 2, there are two sheets in the upper part of the bed (left and right), each controlled by two stepper motors (four in total) that always rotate simultaneously and in opposite directions. They come and can be made of steel or aluminum alloys in which both sides of the sheets are locked.

4. According to claim 3, when the nurse places the sheets by hand (between the grooved tube and the metal rod), the motors are twisted in the opposite direction and the sheets are locked so that The sheets are always rotated together and in the opposite direction, or both outwards or together inwards, and the heavier the patient's weight, the more the sheets lock.

5. There is a green panel at the top that controls the motors and flat jacks.
